(19) United States
(12) Patent Application Publication
(10) Pub. No.: US 2022/0153190 A1
(43) Pub. Date: May 19, 2022

(54) VEHICLE PANEL LIGHT-EMITTING THREE-DIMENSIONAL PATTERN IN GRADATION

(71) Applicants: HYUNDAI MOTOR COMPANY, Seoul (KR); KIA CORPORATION, Seoul (KR)

(72) Inventors: Jae Sik SEO, Hwaseong-si (KR); Wan Dong JO, Seoul (KR); Hong Chan JEON, Seoul (KR)

(73) Assignees: HYUNDAI MOTOR COMPANY, Seoul (KR); KIA CORPORATION, Seoul (KR)

(21) Appl. No.: 17/343,087

(22) Filed: Jun. 9, 2021

(30) Foreign Application Priority Data
Nov. 17, 2020 (KR) 10-2020-0153571

(51) Int. Cl. B60Q 3/74; G02B 6/12; B60Q 3/64; C08L 69/00; G02B 5/02

(52) U.S. Cl. CPC B60Q 3/745; G02B 6/12002; G02B 5/0205; C08L 69/005; B60Q 3/64

(57) ABSTRACT

The vehicle panel includes: a panel main body comprising a three-dimensional pattern part including a three-dimensional pattern engraved on a back surface of the three-dimensional pattern part, and a coating part coated on an upper surface of the three-dimensional pattern part; and a lighting part provided such that the light is emitted from an inner surface of the panel main body, wherein the lighting part comprises: a diffusion plate provided to be spaced at a location corresponding to the panel main body, and a light source located inside the diffusion plate and provided to be spaced apart from the diffusion plate.

### CROSS-REFERENCE TO RELATED APPLICATION

This application claims priority to and the benefit of Korean Patent Application No. 10-2020-0153571, filed on Nov. 17, 2020, the entire contents of which are incorporated herein by reference.

### FIELD

The present disclosure relates to a vehicle panel emitting light in a three-dimensional gradient pattern.

### BACKGROUND

The statements in this section merely provide background information related to the present disclosure and may not constitute prior art.

In recent years, an interior mood lamp within a vehicle often applied for the high quality product. Conventionally, a line-shaped lighting has been popularly applied all over the world, and to apply the above, linear-structured light-emitting objects such as a light guide or a light string have been researched. In recent years, a planar lighting decoration component utilizing a film is mass-produced around the European industry and when an in-mold labeling (IML) or a film of an in-mold decorating (IMD) method is mainly produced, the selective shielding structure is formed and the design pattern by light-transmitting/light-shielding effects is implemented by changing the number of printing colors between film layers. However, since the IML film is considerably expensive compared to the painting due to the surface treatment process, the planar light-emitting lighting component applying the painting and the laser cutting is currently mass-produced. However, in this case, since the laser processing is performed on the surface, a sense of luxury is decreased due to a surface level difference, and if the back surface painting and the laser cutting are to be performed, the surface should be reversed and proceeded, such that the mass productivity is decreased because the defect rate may not be handled.

Meanwhile, the design trend is intended to construct a unique identity using light. According to such a trend, the components mass-produced until today are mostly limited to a two-dimensional product having a line or planar shape. While it may be an open type or a hidden type, and the design is simply implemented only according to whether the light is emitted to a pattern part.

Further, in recent years, the interior lighting is recognized as a design language in a general vehicle brand as well as a luxury vehicle brand, such that the lighting component is mass-produced. As the market for an electric vehicle is rapidly growing, how to express a difference from the conventional internal combustion engine interior is becoming a worldwide concern between the designers, but most of the designers are attempting to find the solution thereto from the lighting component.

Therefore, a vehicle panel which goes beyond the limitation of the conventional simple line-shaped lighting is being developed, but the visibility is lowered or the three-dimensional effect is decreased even in the vehicle panel including the three-dimensional pattern.

The above information disclosed in this Background section is only for enhancement of understanding of the background of the disclosure and accordingly it may include information that does not form the prior art that is already known to a person of ordinary skill in the art.

### SUMMARY

The present disclosure provides a vehicle panel including a panel main body including an engraved three-dimensional pattern; and a lighting part including a diffusion plate provided such that the light is emitted from the inner surface of the panel main body to maximally provide a light-emitting region, and a light source provided to be spaced apart from the inside of the diffusion plate to provide the three-dimensional effect, and to reduce the loss of the light source.

A vehicle panel according to one form of the present disclosure includes: a panel main body including a three-dimensional pattern part having a three-dimensional pattern engraved on the back surface thereof, and a coating part coated on the upper surface of the three-dimensional pattern part; and a lighting part located such that the light is emitted from the inner surface of the panel main body, in which the lighting part includes: a diffusion plate provided to be spaced at a location corresponding to the panel main body, and a light source located inside the diffusion plate and provided to be spaced apart from the diffusion plate.

The three-dimensional pattern may be engraved in the thickness of 0.2 to 1.5 mm.

The three-dimensional pattern may include: one or more shape selected from a group consisting of a rectangular parallelepiped shape, a trapezoidal shape, a diamond shape, a hemispherical shape, and a combination thereof.

The three-dimensional pattern part may include one or more types selected from a group consisting of polycarbonate (PC), poly(methyl methacrylate (PMMA), polycarbonate/polyethylene terephthalate glycol (PC/PETG) composite, acrylonitrile butadiene styrene (ABS) copolymer, a PC/ABS composite, and a combination thereof.

The polycarbonate (PC) may be selected from a group consisting of transparent polycarbonate, opaque polycarbonate, and a combination thereof.

The opaque polycarbonate may include: the polycarbonate of 99.991 to 99.997 wt %; and the pigment of 0.003 to 0.009 wt % including the carbon black.

The coating part may include: one or more paints selected from a group consisting of achromatic paint, chromatic paint, and a combination thereof and a pigment.

The coating part may include: the paint of 95 to 99.5 wt % and the pigment of 0.5 to 5 wt %.

The thickness of the coating part may be 2 to 22 um.

The diffusion plate may include: a diffusion agent including one or more types selected from a group consisting of silicone dioxide (SiO₂), silicone rubber, titanium dioxide (TiO₂), and PMMA.

The content of the diffusion agent is 0.5 to 2 wt % based on the entire 100 wt % of the diffusion plate.

A separation distance between the light source and the diffusion plate may be 10 to 15 mm.

A separation distance between the diffusion plate and the three-dimensional pattern part may be 2 to 4 mm.

The diffusion plate may have the increasing thickness from the center portion toward the outer portion.

The thickness of the diffusion plate may be 1.5 to 3.8 mm.

The lighting part may further include: a diffusion film located on the upper surface of the diffusion plate.

The diffusion film may include: one or more materials selected from a group consisting of polycarbonate (PC), poly(methyl methacrylate (PMMA), and polyethylene terephthalate (PET).

The light-emitted three-dimensional pattern may have the luminance of 0.5 to 6 cd/m², the transmittance of 1 to 30%, and the brightness (L*) of 2 to 40.

The contrast of the light-emitted three-dimensional pattern may be adjusted by adjusting the brightness (L*).

The vehicle panel may include: one or more types selected from a group consisting of an embedded component garnish, a bumper garnish, a rear garnish, a tailgate garnish, a front garnish, a side garnish, a filler garnish, a fender garnish, a side step garnish, a front door molding, a front rear molding, a bumper molding, a door scuff, a label, and a combination thereof.

The vehicle panel according to the present disclosure includes the three-dimensional pattern part including the engraved three-dimensional pattern on the panel main body, thereby saving the cost desired for the laser cutting and complementing the lowered a sense of luxury of the conventional panel and lowered mass productivity due to the high defect rate. Furthermore, because the light source is radiated from the inside instead of the conventional method of radiating the light to the side surface, thereby the loss of the light source is reduced and the light-emitting region is maximally provided using the diffusion plate. By providing the light source inside the diffusion plate to be spaced apart from the diffusion plate by a specific distance, the three-dimensional effect of the light-emitted three-dimensional pattern and the gradation effect are improved to enhance the aesthetic sense and a sense of luxury.

The effect of the present disclosure is not limited to the aforementioned effects. The effect of the present disclosure should be understood as including all effects inferable from the following description.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional diagram schematically illustrating a vehicle panel according to one form of the present disclosure;

FIG. 2 is a cross-sectional diagram schematically illustrating a panel main body of the vehicle panel according to one form of the present disclosure;

FIG. 3 is a diagram illustrating images for confirming whether vehicle panels according to Example 1-1-1 to Example 1-1-3 and vehicle panels according to Comparative Example 1-1-1 to Comparative Example 1-1-4, Comparative Example 2-1-1 to Comparative Example 2-1-7, Comparative Example 3-1-1 to Comparative Example 3-1-7, and Comparative Example 4-1-1 to Comparative Example 4-1-7 according to the present disclosure may identify three-dimensional patterns during the day;

FIG. 4 is a graph measuring the luminance of the three-dimensional patterns light-emitted from the vehicle panels according to the Example 1-1-1 to the Example 1-2-3, and the Comparative Example 1-1-1 to the Comparative Example 1-2-4;

FIG. 5 is a graph measuring the luminance of the three-dimensional patterns light-emitted from the vehicle panels according to the Comparative Example 2-1-1 to the Comparative Example 2-1-7, and the Comparative Example 2-2-1 to the Comparative Example 2-2-7;

FIG. 6 is a graph measuring the luminance of the three-dimensional patterns light-emitted from the vehicle panels according to the Comparative Example 3-1-1 to the Comparative Example 3-1-7, and the Comparative Example 3-2-1 to the Comparative Example 3-2-7;

FIG. 7 is a graph measuring the luminance of the three-dimensional patterns light-emitted from the vehicle panels according to the Comparative Example 4-1-1 to the Comparative Example 4-1-7, and the Comparative Example 4-2-1 to the Comparative Example 4-2-7;

FIG. 8 is a graph illustrating the correlation between the luminance and the transmittance evaluated in the vehicle panels according to the Example 1-1-1 to the Example 1-2-3 and the vehicle panels according to the Comparative Example 1-1-1 to the Comparative Example 1-2-4, the Comparative Example 2-1-1 to the Comparative Example 2-2-7, the Comparative Example 3-1-1 to the Comparative Example 3-2-7, and the Comparative Example 4-1-1 to the Comparative Example 4-2-7.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. In the accompanying drawings, the dimensions of the structures are illustrated to be enlarged than the actual one for clarity of the present disclosure.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof. Further, when a portion such as a layer, a film, an area, or a plate is said to be “on” another portion, this includes not only the case where the portion is “directly above” another portion but also the case where other portions are interposed therebetween. Conversely, when a portion such as a layer, a film, an area, or a plate is said to be “under” another portion, this includes not only the case where the portion is “directly under” another portion but also the case where other portions are interposed therebetween.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values. Further, where a numerical range is disclosed herein, such a range is continuous, and includes unless otherwise indicated, every value from the minimum value to and including the maximum value of such range. Still further, where such a range refers to integers, unless otherwise indicated, every integer from the minimum value to and including the maximum value is included.

In the present specification, if a range is described for a variable, it will be understood that the variable includes all values within the described range including the described endpoints of the range. For example, it will be understood that a range of “5 to 10” includes not only values of 5, 6, 7, 8, 9, and 10 but also any sub-range such as 6 to 10, 7 to 10, 6 to 9, and 7 to 9, and also includes any value between reasonable integers within the scope of the described ranges such as 5.5, 6.5, 7.5, 5.5 to 8.5, 6.5 to 9, and the like. Further, it will be understood that a range of “10% to 30%” includes, for example, not only all integers including values, such as 10%, 11%, 12%, and 13%, and 30% but also any sub-range such as 10% to 15%, 12% to 18%, and 20% to 30%, and also includes any value between reasonable integers within the scope of the described range, such as 10.5%, 15.5%, and 25.5%.

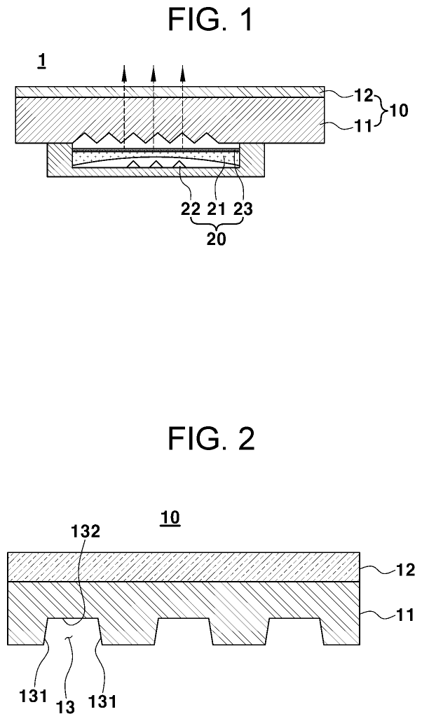

FIG. 1 is a cross-sectional diagram schematically illustrating a vehicle panel 1 according to one form of the present disclosure. Referring to FIG. 1, the vehicle panel 1 includes a panel main body 10 exposed in appearance and a lighting part 20 located such that the light is emitted from the inner surface of the panel main body.

Each component included in the vehicle panel will be described in detail below.

Panel Main Body

The panel main body according to one form of the present disclosure is not specially limited as long as a three-dimensional pattern is hidden during the day and thus it is difficult to visually identify the three-dimensional pattern, but the light-emitting three-dimensional pattern may be visually identified when the light source is turned on at night and the expressiveness of the edge portion of the three-dimensional pattern may be improved.

### (1) Three-Dimensional Pattern Part

FIG. 2 is a cross-sectional diagram schematically illustrating the panel main body 10 of the vehicle panel 1 according to one form of the present disclosure. Referring to FIG. 2, the vehicle panel 1 includes a three-dimensional pattern part 11 in which a three-dimensional pattern is engraved on the back surface thereof, and a coating part 12 provided on the upper surface of the three-dimensional pattern part.

The three-dimensional pattern part 11 according to one form of the present disclosure may have a plurality of three-dimensional patterns engraved on the back surface thereof, and is not specially limited as long as it may have a good hiding property when the light of the light source is not radiated but improve the expressiveness of the three-dimensional effect when the light of the light source is radiated.

A shape of the three-dimensional pattern according to the present disclosure is not specially limited as long as it has good expressiveness of the edge portion of the three-dimensional pattern and has the three-dimensional appearance having the aesthetic sense and a sense of luxury. Preferably, the three-dimensional pattern part 11 includes a plurality of cell parts impregnated to be perpendicular or inclined from the back surface of the three-dimensional pattern part toward the upper surface thereof, and the cell part 13 may include a side surface 131 impregnated to be perpendicular or inclined; and a bottom surface 132 having a predetermined shape partitioned by the side surface. The side surface of the cell part may be impregnated to be perpendicular or inclined, but may include the side surface having the radius of curvature which is constant, increases, or decreases, and the bottom surface having a predetermined shape partitioned by the side surface. Therefore, the shape of the bottom surface includes one selected from a group consisting of a square, a diamond, a hemispherical shape, a circular shape, an elliptical shape, and a combination thereof, and preferably, the shape of the three-dimensional pattern may include a rectangular parallelepiped shape having the same rectangular engraved area from the back surface toward the upper surface, a trapezoidal shape having the decreased or increased rectangular engraved area from the back surface toward the upper surface, a diamond shape having the decreased or increased diamond-shaped engraved area from the back surface toward the upper surface, and a hemispherical shape having the decreased circular engraved area from the back surface toward the upper surface.

The base material of the three-dimensional pattern part 11 according to the present disclosure is not specially limited as long as it may have the light-transmitting property to transmit light. Preferably, the base material of the three-dimensional pattern part 11 may be a plastic transmitting the light and having good shock resistance, and more preferably, may include one or more types selected from a group consisting of polycarbonate (PC), poly(methyl methacrylate) (PMMA), polycarbonate/polyethylene terephthalate glycol (PC/PETG) composite, acrylonitrile butadiene styrene (ABS) copolymer, a PC/ABS composite, and a combination thereof, and much more preferably, may be the polycarbonate (PC), which may excellently transmit the light, have good shock resistance, and be efficiently engraved.

The three-dimensional pattern part 11 according to one form of the present disclosure may be a transparent three-dimensional pattern part having a transparent material including the base material, or an opaque three-dimensional pattern part capable of adding the pigment and the diffusion agent to the base material to enhance the three-dimensional effect of the shape of each three-dimensional pattern. For example, the three-dimensional pattern part including polycarbonate may be the three-dimensional pattern part including polycarbonate or the three-dimensional pattern part including the opaque polycarbonate with added pigment and diffusion agent. Preferably, the three-dimensional pattern part 11 may be the three-dimensional pattern part including the opaque polycarbonate which may provide the three-dimensional texture and the light-emitting luminance and have good expressiveness of the pattern edge portion without lowering the hiding power, thereby enhancing the three-dimensional effect.

The opaque polycarbonate included in the three-dimensional pattern part may be added with the diffusion agent, the pigment, and the like, but preferably, added with only the pigment rather than the diffusion agent in order to inhibit the three-dimensional effect from being lowered and to inhibit the light-emitting luminance and turbidity from being decreased by the diffusion effect. The pigment is not specially limited as long as it may provide the hiding power and improve the three-dimensional effect, and for example, may be silica, titanium dioxide, azoic-based compounds, phthalocyanine-based compounds, preferably, carbon black-based pigment. As the content of the carbon black is increased, the paint of the coating part to be described later may be omitted. Therefore, the opaque poly carbonate according to the present disclosure may be the polycarbonate of 99.991 to 99.997 wt % and the pigment of 0.003 to 0.009 wt % including the carbon black, and an amount of the pigment including the carbon black may be flexibly adjusted according to an amount of the pigment added to the coating part to be described later. When the wt % of the polycarbonate is less than 99.991 wt %, the transmittance is lowered; when the light is radiated by the light source, there is a concern in which the edge line of the pattern is highlighted to increase the artificial disharmony; and when the wt % of the polycarbonate exceeds 99.997 wt %, the hiding property may be lowered or the three-dimensional effect may be lowered at the front angle. Further, when the wt % of the pigment including the carbon black is less than 0.003 wt %, the inner structure within the three-dimensional pattern part may be projected even without the light passing through, and when the wt % of the pigment including the carbon black exceeds 0.009 wt %, the lighting effect may be lowered, thereby decreasing the three-dimensional effect.

The engraved depth of the three-dimensional pattern according to the present disclosure is not specially limited as long as it is the degree of having good shock resistance even without the lack of the three-dimensional effect of the design pattern, and considering the three-dimensional effect and the shock resistance according to the base material and the three-dimensional shape, the engraved depths may be changed, respectively. For example, the three-dimensional pattern of the three-dimensional pattern part including polycarbonate may be engraved by the depth of 0.2 to 1.5 mm. When the engraved depth is less than 0.2 mm, the three-dimensional effect may be lacked, and when the engraved depth exceeds 1.5 mm, the shock property of the vehicle panel may be lowered.

The thickness of the three-dimensional pattern part (the entire thickness of the substrate rather than the depth of the pattern part) according to the present disclosure is not specially limited as long as it is the degree of having good shock resistance and maintaining the three-dimensional effect. Preferably, the depth of the three-dimensional pattern part may be 1.5 mm to 3 mm. When the thickness of the three-dimensional pattern part is less than 1.5 mm, the flowing property is lowered in the case of a large-area component such as a garnish, such that the injection molding is difficult and the surface sink of the applied pattern excessively occurs. When the depth of the three-dimensional pattern part exceeds 3 mm, the sink of the three-dimensional pattern part occurs due to the excessive contraction, thereby causing the appearance defects or significantly decreasing transmittance and luminance and as a result, it is difficult to apply the three-dimensional pattern part as the lighting component.

(2) Coating Part

The coating part 12 according to one form of the present disclosure is not specially limited as long as it is coated on the upper portion of the three-dimensional pattern part, the appearance of the coating part may be identified while enhancing the hiding property of the three-dimensional pattern part, including the three-dimensional pattern, when the light is not incident, and the three-dimensional effect of the three-dimensional pattern part is not decreased when the light is incident.

The coating part according to one form of the present disclosure may be identified as an achromatic color or a chromatic color during the day, and preferably, may include one or more paints selected from a group consisting of the achromatic paint, the chromatic paint, and a combination thereof, and for example, as the achromatic paint, there may be the metallic paint, the general matte paint, the high elasticity paint, the soft texture paint, or the white pigment, and preferably, may be a transparent black high glossy paint, and as the chromatic paint, there may be the general solid color paint, the tinted painting, or the like. More preferably, the light-transmitting black high glossy paint may be a coating type 2 or a coating type 1, and preferably, the clear coating type 1. The high glossy paint may be coated in an UV curing type or a heat curing type. Therefore, a specific pattern expressed by the coating part, for example, the appearance such as wood, metallic, high glossy, or the like may be implemented during the day.

Further, the coating part according to one form of the present disclosure may add the pigment in order to improve the hiding function and the light-transmitting function for the three-dimensional pattern included in the three-dimensional pattern part. The pigment may be, for example, the nano-sized carbon black, and preferably, may be a composite of nano-sized carbon black and azoic-based compounds and phthalocyanine-based compounds.

Preferably, the coating part may include the paint of 95 to 99.5 wt % and the pigment of 0.5 to 5 wt %. When the wt % of the paint is less than 95 wt % or the wt % of the pigment is less than 0.5 wt %, the hiding property is lowered, and when the wt % of the paint exceeds 99.5 wt % or the wt % of the pigment exceeds 5 wt %, the lighting transmissible property is lowered.

Further, the present disclosure may adjust the thickness of the coating part to obtain the effect of adding the pigment of 0.5 to 5 wt %. Specifically, based on the thickness of the coating part of 21 to 22 um (100%) in which the pigment included in the paint is fixed to 5 wt %, the coating part may be manufactured in the thickness of 18 to 19 urn (90%) in order to manufacture the coating part including the pigment of 4.5%; the coating part may be manufactured in the thickness of 14 to 15 um (70%) in order to manufacture the coating part including the pigment of 3.5%; the coating part may be manufactured in the thickness of 10 to 11 um (50%) in order to manufacture the coating part including the pigment of 2.5%; the coating part may be manufactured in the thickness of 6 to 7 um (30%) in order to manufacture the coating part including the pigment of 1.5%; and the coating part may be manufactured in the thickness of 2 to 3 um (10%) in order to manufacture the coating part including the pigment of 0.5%. Therefore, the wt % of the pigment may be adjusted by adjusting the thickness of the coating part without adjusting the wt % of the pigment included in the paint.

Lighting Part

The bottom portion of FIG. 1 is a cross-sectional diagram schematically illustrating the lighting part 20 of the vehicle panel 1 according to one form of the present disclosure. Referring to the bottom portion of FIG. 1, the light part located such that the light is emitted from the inner surface of the panel main body may include a diffusion plate 21 provided at a location corresponding to the panel main body; and a light source 22 provided to be spaced apart from the inside of the diffusion plate, and further include a diffusion film 23 located on the diffusion plate.

Diffusion Plate

The diffusion plate 21 according to the present disclosure is not specially limited as long as it is separately provided by corresponding to the three-dimensional pattern included in the three-dimensional pattern part of the panel main body, thereby maximally providing the light-emitting region of the light source.

The diffusion plate according to one form the present disclosure may have a separation distance with the three-dimensional pattern part within the panel main body in order to provide the three-dimensional effect and the gradation effect, and the separation distance with the light source may be set as a specific distance. Specifically, the separation distance between the light source and the diffusion plate may be 10 to 15 mm, and the separation distance between the diffusion plate and the three-dimensional pattern part may be 2 to 4 mm. When the separation distance between the light source and the diffusion plate is less than 10 mm or the separation distance between the diffusion plate and the three-dimensional pattern part is less than 2 mm, the visibility of the three-dimensional pattern edge at which the three-dimensional pattern part of the panel main body is radiated and shown by the light source may be lowered or the gradation effect thereof may be lowered, and when the separation distance between the light source and the diffusion plate exceeds 15 mm or the separation distance between the diffusion plate and the three-dimensional pattern part exceeds 4 mm, there is the possibility of lowering the light luminance or causing the interference with the adjacent component due to the door trim shape.

The diffusion plate according to one form of the present disclosure may have the shape in which the thickness is increased from the center portion toward the outer portion, and have a hemispherical-shaped cross section in which the panel main body side of the diffusion plate has a flat shape and the light source side thereof is impregnated from the light source toward the panel main body. The diffusion plate having the above shape is characterized by improving the gradation effect of the three-dimensional pattern.

The thickness of the diffusion plate according to the present disclosure may be 1.5 to 3.8 mm, and preferably, the center portion of the diffusion plate may be 1.5 mm, or the outer portion thereof may be 3.5 mm. When the thickness of the diffusion plate is less than 1.5 mm, the light diffusion effect may be lowered, thereby causing the hot spot, and when the thickness of the diffusion plate exceeds 3.8 mm, the luminance is lowered.

The diffusion plate according to the present disclosure is not specially limited as long as it has the light-transmitting property to transmit the light. Preferably, the diffusion plate may be a plastic transmitting the light and having a good shock resistance, more preferably, may include one type selected from a group consisting of polycarbonate (PC), poly(methyl methacrylate) (PMMA), polycarbonate/polyethylene terephthalate glycol (PC/PETG) composite, acrylonitrile butadiene styrene copolymer (ABS), a PC/ABS composite, and a combination thereof, and much more preferably, the polycarbonate (PC) capable of excellently transmitting the light and having the good shock resistance.

Further, the diffusion plate may further include a diffusion agent in order to improve the diffusion effect of the light radiated by the light source. The diffusion agent may include one or more type selected from a group consisting of SiO₂, silicone rubber, TiO₂, and PMMA, and does not include a specific component, but preferably includes a spherical SiO₂.

The diffusion agent preferably includes the content of 0.5 to 2 wt % based on the total 100 wt % of the diffusion plate. When the content of the diffusion agent is less than 0.5 wt %, the diffusion effect is insufficient, thereby causing the hot spot, and when the content of the diffusion agent exceeds 2 wt %, the transmittance is lowered.

Further, the diffusion plate may be add with a particle additive instead of the diffusion agent in order to induce light scattering, and the particle additive may include one or more type selected from a group consisting of TiO₂, PMMA, silicone rubber, and TiO₂, and is not limited as including a specific component.

(2) Light Source

The light source 22 according to the present disclosure is not specially limited as long as it is provided on the side portion of a light guide plate to emit the light. The light source according to one form of the present disclosure may use an LED capable of emitting the light in various colors (red/blue/white, and the like), and may be mainly provided to be simultaneously turned on together with the headlights and taillights of the vehicle, which are to be turned on at night, and preferably, may be provided with a circuit such that the light source may simultaneously receive the vehicle power source to be turned on when the driver operates a multi-functional switch to turn on the headlights or the taillights.

(3) Diffusion Film

The diffusion film 23 according to the present disclosure is not specially limited as long as it is located on the upper surface of the diffusion plate, such that the light of the light source radiated to transmit the diffusion plate transmits the diffusion film, thereby further enhancing the gradation effect of the light-emitted three-dimensional pattern.

The diffusion film according to one form of the present disclosure may be a transparent film including one or more types selected from a group consisting of polycarbonate (PC), poly(methyl methacrylate) (PMMA), and PET, and is not limited as including a specific component.

The diffusion film may be manufactured through gravure printing, thermoelectric transfer micro-printing, or the like, and preferably, is not specially limited as long as it may sharpen the light-emitted three-dimensional pattern while enhancing the gradation effect by conducting the thermoelectric transfer micro-printing.

Vehicle Panel

The vehicle panel according to one form of the present disclosure is included in the lighting part, and the light of the light source located inside the diffusion plate may be incident to the diffusion plate, and the incident light transmits the diffusion plate and a diffusion sheet and is radiated to the panel main body, such that the three-dimensional pattern may be light-emitted.

Particularly, the vehicle panel including the panel main body and the lighting part according to one form of the present disclosure may have the transmittance of 2 to 10% and the brightness (L*) of 2 to 3 during the day, thereby not identifying the three-dimensional pattern. However, the light-emitted three-dimensional pattern may have the luminance of 0.5 to 6 cd/m², the transmittance of 1 to 30%, and the brightness (L*) of 2 to 40 at night, and preferably, the luminance of 1 to 3 cd/m², the transmittance of 3 to 10%, and the brightness (L*) of 3 to 10.

That is, the vehicle panel according to the present disclosure has the characteristics in that as a hidden type, the three-dimensional pattern is hidden during the day, thereby not easily, visually identifying the three-dimensional pattern. However, the specific pattern such as the high glossy of the coating part is identified. The light-emitted three-dimensional pattern may be visually identified and the expressiveness of the edge portion of the three-dimensional pattern is good when the light source is turned on at night, and may adjust the contrast of the light-emitted three-dimensional pattern by adjusting the contrast, radiate the light source from the inside, thereby reducing the loss of the light source, and maximally providing the light-emitting region using the diffusion plate, and locate the light source inside the diffusion plate to be spaced apart from the diffusion plate by a specific distance, thereby enhancing the three-dimensional effect of the light-emitted three-dimensional pattern and improving the gradation effect to enhance the aesthetic sense and a sense of luxury.

Therefore, the vehicle panel according to the present disclosure may include one or more types selected from a group consisting of an embedded component garnish, a bumper garnish, a rear garnish, a tailgate garnish, a front garnish, a side garnish, a filler garnish, a fender garnish, a side step garnish, a front door molding, a front rear molding, a bumper molding, a door scuff, a label, and a combination thereof.

Hereinafter, the present disclosure will be described in more detail through the Examples. The following Examples are merely illustrative for heling to understand the present disclosure, and the scope of the present disclosure is not limited thereto.

### Example 1-1-1

(Three-dimensional pattern part) an opaque carbonate (smoky 100%; SM100) including the polycarbonate of 99.994 wt % and the pigment of 0.006 wt % including the carbon black was manufactured by mixing polycarbonate (PC) and the pigment including the carbon black, as the base material, using a 2-axis extruder. At this time, the three-dimensional pattern part was composed of a plurality of cell parts having the thickness of 3.0 mm, and the shape of the three-dimensional pattern included in the three-dimensional pattern part with the diamond-shaped bottom surface, and the engraved depth was 0.2 to 0.8 mm.

(Coating part) the coating part was manufactured by mixing the light-transmitting black high glossy paint as the achromatic paint and the carbon black, the azoic-based compounds, and the phthalocyanine-based compounds as the pigment, and then the manufactured coating part was coated on the upper surface of the manufactured three-dimensional pattern part with the UV curing type. Specifically, based on the thickness of the coating part of 21 to 22 um (100%) in which the pigment included in the paint is fixed to 5 wt %, the light-transmitting high glossy paint and the pigment mixing the carbon black, the azoic-based compounds, and the phthalocyanine-based compounds was mixed, and then the coating part was manufactured in the thickness of 6 to 7 um (30%), such that the coating part including the pigment of 1.5% was manufactured.

(Diffusion plate) the diffusion plate was manufactured in the shape of the semi-circular structure in which the center portion is 1.5 mm, or the outer portion is 3.5 mm based on the cross section of the diffusion plate. The diffusion plate was manufactured by using the PC as the base material, and included the diffusion agent including SiO₂ by 1.5% based on the total 100 wt % of the diffusion plate. The diffusion plate had the separation distance of 4 mm with the three-dimensional pattern part and the separation distance of 15 mm with the light source.

(Diffusion film) the transparent diffusion film using the PET as a raw material was manufactured by the thermoelectric micro-printing and was provided on the upper surface of the diffusion plate.

(Light source) the light source was provided inside the diffusion plate so as to have the separation distance with the diffusion plate by 15 mm using a white 1-chip light-emitting diode (LED), such that the vehicle panel according to the present disclosure was finally manufactured. Various changes of colors may be induced by applying an RGB LED.

### Example 1-1-2 and Example 1-1-3

When compared with the Example 1-1-1, the vehicle panel was manufactured in the same method as that of the Example 1-1-1, excluding that the coating part was manufactured in the thickness of 10 to 11 um (50%), such that the coating part including the pigment of 2.5% was manufactured (Example 1-1-2), or the coating part was manufactured in the thickness of 14 to 15 um (70%), such that the coating part including the pigment of 3.5% was manufactured (Example 1-1-3).

### Example 1-2-1 to Example 1-2-3

When compared with the Example 1-1-1 to the Example 1-1-3, the vehicle panel was manufactured in the same method as that of the Example 1-1-1 to the Example 1-1-3, except that the three-dimensional pattern part was manufactured in the thickness of 1.5 mm rather than 3.0 mm.

### Comparative Example 1-1-1 to Comparative Example 1-1-4

When compared with the Example 1-1-1, the vehicle panel was manufactured in the same method as that of the Example 1-1-1, except that the coating part not including the pigment was manufactured as the coating part (Comparative Example 1-1-1); the coating part was manufactured in the thickness of 2 to 3 um (10%), such that the coating part including the pigment of 0.5% was manufactured (Comparative Example 1-1-2); the coating part was manufactured in the thickness of 18 to 19 um (90%), such that the coating part including the pigment of 4.5% was manufactured (Comparative Example 1-1-3); or the coating part was manufactured in the thickness of 21 to 22 um (100%), such that the coating part including the pigment of 5.0% was manufactured (Comparative Example 1-1-4).

### Comparative Example 1-2-1 to Comparative Example 1-2-4

When compared with the Examples 1-2-1 to 1-2-4, the vehicle panel was manufactured in the same method as that of the Examples 1-2-1 to 1-2-4, except that the three-dimensional pattern part was manufactured in the thickness of 1.5 mm rather than 3.0 mm.

### Comparative Example 2-1-1 to Comparative Example 2-1-7

When compared with the Example 1-1-1, using the transparent polycarbonate (transparent PC; SM0) not including the pigment instead of the opaque polycarbonate included in the three-dimensional pattern part, the vehicle panel was manufactured in the same method as that of the Example 1-1-1, except that the coating part not including the pigment was manufactured as the coating part (Comparative Example 2-1-1); the coating part was manufactured in the thickness of 2 to 3 um (10%), such that the coating part including the pigment of 0.5% was manufactured (Comparative Example 2-1-2); the coating part was manufactured in the thickness of 6 to 7 um (30%), such that the coating part including the pigment of 1.5% was manufactured (Comparative Example 2-1-3); the coating part was manufactured in the thickness of 10 to 11 um (50%), such that the coating part including the pigment of 2.5% was manufactured (Comparative Example 2-1-4); the coating part was manufactured in the thickness of 14 to 15 um (70%), such that the coating part including the pigment of 3.5% was manufactured (Comparative Example 2-1-5); the coating part was manufactured in the thickness of 18 to 19 um (90%), such that the coating part including the pigment of 4.5% was manufactured (Comparative Example 2-1-6); or the coating part was manufactured in the thickness of 21 to 22 um (100%), such that the coating part including the pigment of 5.0% was manufactured (Comparative Example 2-1-7).

### Comparative Example 2-2-1 to Comparative Example 2-2-7

When compared with the Comparative Example 2-1-1 to the Comparative Example 2-1-7, the vehicle panel was manufactured in the same method as that of the Comparative Example 2-1-1 to the Comparative Example 2-2-7, except that the three-dimensional pattern part was manufactured in the thickness of 1.5 mm rather than 3.0 mm.

### Comparative Example 3-1-1 to Comparative Example 3-1-7

When compared with the Comparative Example 2-1-1 to the Comparative Example 2-1-7, the vehicle panel was manufactured in the same method as that of the Comparative Example 2-1-1 to the Comparative Example 2-1-7, except that the opaque carbonate (smoky 50%; SM50), including the polycarbonate of 99.997 wt % and the pigment of 0.003 wt % including the carbon black, rather than the transparent polycarbonate included in the three-dimensional pattern part was used.

### Comparative Example 3-2-1 to Comparative Example 3-2-7

When compared with the Comparative Example 3-1-1 to the Comparative Example 3-1-7, the vehicle panel was manufactured in the same method as that of the Comparative Example 3-1-1 to the Comparative Example 3-2-7, except that the three-dimensional pattern part was manufactured in the thickness of 1.5 mm rather than 3.0 mm.

### Comparative Example 4-1-1 to Comparative Example 4-1-7

When compared with the Comparative Example 2-1-1 to the Comparative Example 2-1-7, the vehicle panel was manufactured in the same method as that of the Comparative Example 2-1-1 to the Comparative Example 2-1-7, except that the opaque carbonate (smoky 150%; SM150), including the polycarbonate of 99.991 wt % and the pigment of 0.009 wt % including the carbon black, rather than the transparent polycarbonate included in the three-dimensional pattern part was used.

### Comparative Example 4-2-1 to Comparative Example 4-2-7

When compared with the Comparative Example 4-1-1 to the Comparative Example 4-1-7, the vehicle panel was manufactured in the same method as that of the Comparative Example 4-1-1 to the Comparative Example 4-2-7, except that the three-dimensional pattern part was manufactured in the thickness of 1.5 mm rather than 3.0 mm.

### Experimental Example 1—Hiding Property Evaluation of the Vehicle Panel According to the Pigment Included in the Three-Dimensional Pattern Part and the Pigment Included in the Coating Part

An optimal pigment component range capable of sufficiently hiding the three-dimensional pattern during the day was confirmed by comparing the hiding properties of the vehicle panels according to the Example 1-1-1 to the Example 1-1-3; and the vehicle panels according to the Comparative Example 1-1-1 to the Comparative Example 1-1-4, the Comparative Example 2-1-1 to the Comparative Example 2-1-7, the Comparative Example 3-1-1 to the Comparative Example 3-1-7, and the Comparative Example 4-1-1 to the Comparative Example 4-1-7.

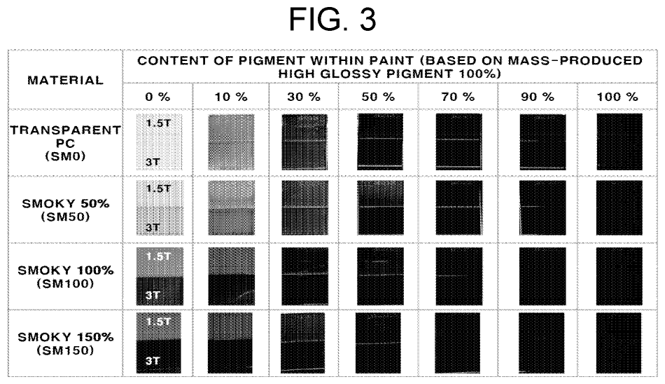

As a result, as illustrated in FIG. 3, in the vehicle panels according to the Example 1-1-1 to the Example 1-1-3, the three-dimensional pattern included in the three-dimensional pattern part was not visually identified during the day. On the other hand, in the Comparative Example 1-1-1 and the Comparative Example 1-1-2, the three-dimensional pattern was partially identified. As in the Comparative Example 1-1-3 and the Comparative Example 1-1-4, if the pigment included in the coating part exceeds 4.5 wt % (70%), there was no discrimination power as in other Comparative Examples, and later, the lighting effect was lowered in the luminance, transmittance, and brightness evaluation, thereby not clearly identifying the three-dimensional effect of the three-dimensional pattern.

Therefore, in the vehicle panel according to one form of the present disclosure including the three-dimensional pattern part including the opaque carbonate including the polycarbonate of 99.994 wt % and the pigment of 0.006 wt % including the carbon black and the coating part manufactured in the thickness of 6 to 15 um (30 to 70%) so as to include the pigment of 1.5% to 3.5%, the three-dimensional pattern was not visually identified during the day but a specific pattern such as high glossy expressed by the coating part could be identified, and the three-dimensional effect of the light-emitted three-dimensional pattern was well expressed even if the light source is turned on at night and the light is radiated. Furthermore, by radiating the light source from the inside instead of the conventional method for radiating the light source to the side surface, it was possible to reduce the loss of the light source and maximally provide the light-emitting region using the diffusion plate, and by locating the light source inside the diffusion plate to be spaced apart from the diffusion plate by a specific distance, it was possible to enhance the three-dimensional effect and implement the gradation effect.

### Experimental Example 2—Evaluation for Luminance and Transmittance of the Vehicle Panel According to the Pigment Included in the Three-Dimensional Pattern Part and the Pigment Included in the Coating Part

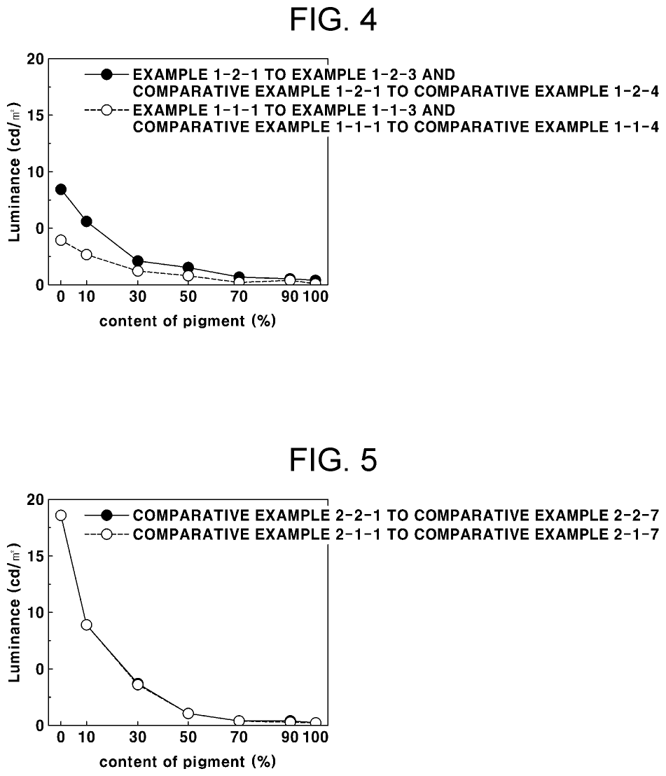

FIGS. 4 to 7 illustrate the results of the evaluation for the luminance of the vehicle panels according to the Example 1-1-1 to the Example 1-2-3; and the vehicle panels according to the Comparative Example 1-1-1 to the Comparative Example 1-2-4, the Comparative Example 2-1-1 to the Comparative Example 2-2-7, the Comparative Example 3-1-1 to the Comparative Example 3-2-7, and the Comparative Example 4-1-1 to the Comparative Example 4-2-7.

The reference luminance for evaluating the luminance was evaluated based on the luminance of the diffusion film provided on the upper surface of the diffusion plate to have the light of the light source transmitted through the diffusion plate (reference luminance of 19.8 cd/m²), and the luminance of at least 1 cd/m² was desired to identify the light-emitted three-dimensional panel.

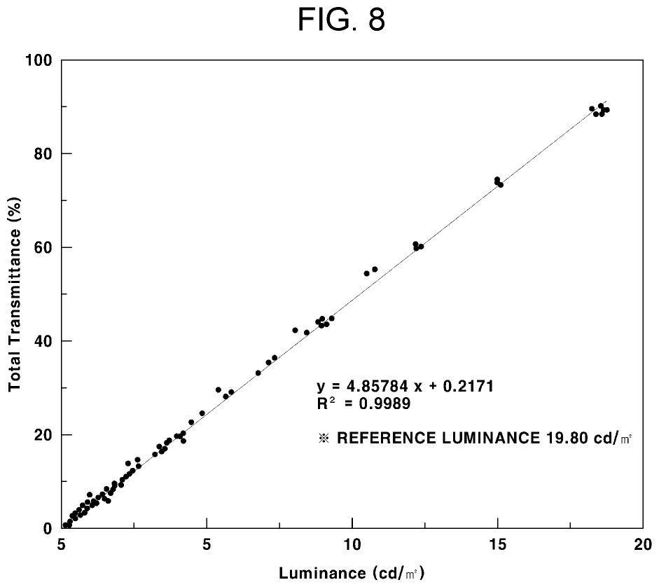

Further, FIG. 8 is a graph illustrating the correlation of the luminance and the transmittance evaluated in the vehicle panels according to the Example 1-1-1 to the Example 1-2-3; and the vehicle panels according to the Comparative Example 1-1-1 to the Comparative Example 1-2-4, the Comparative Example 2-1-1 to the Comparative Example 2-2-7, the Comparative Example 3-1-1 to the Comparative Example 3-2-7, and the Comparative Example 4-1-1 to the Comparative Example 4-2-7. Referring to FIG. 8, it may be confirmed that as the luminance increases, the transmittance proportionally increases.

Referring to the contents in FIG. 8, as illustrated in FIG. 4, it may be confirmed that the three-dimensional effect of the light-emitted three-dimensional pattern in the vehicle panels according to the Example 1-1-1 to the Example 1-2-3 is superior to the vehicle panels according to the Comparative Example 1-1-1 to the Comparative Example 1-2-4 even based on the front surface.

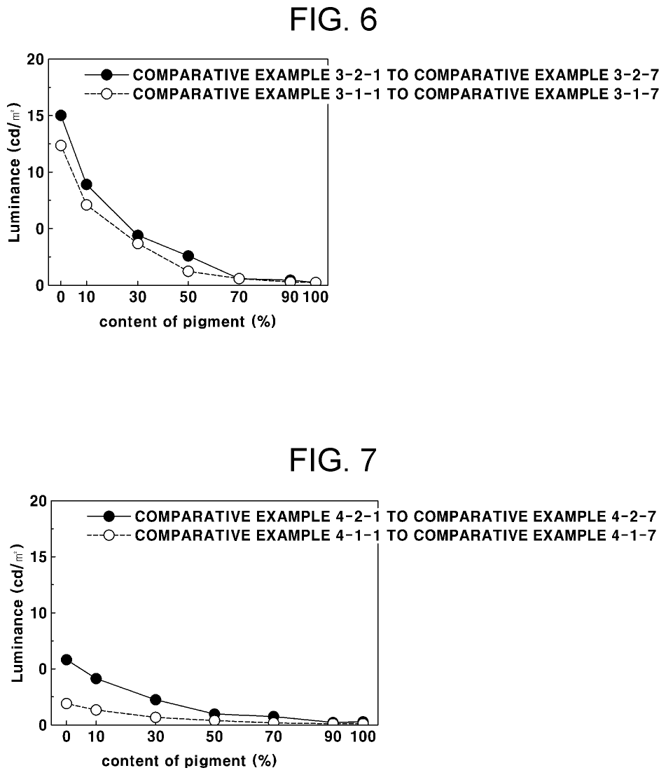

On the other hand, as illustrated in FIGS. 5 and 6, in the Comparative Example 2-1-1 to the Comparative Example 2-2-7, and the Comparative Example 3-1-1 to the Comparative Example 3-2-7, if the pigment included in the coating part exceeds 4.5 wt % (70%), the lighting effect is lowered to less than the luminance of 0.5 cd/m² and less than the transmittance of 1%, thereby not clearly identifying the three-dimensional effect of the three-dimensional pattern. If the pigment included in the coating part is less than 4.5 wt % (70%), the luminance and the transmittance are above the level capable of identifying the three-dimensional pattern, but the expressiveness of the edge portion of the pattern is lowered, thereby decreasing the three-dimensional effect, or as in the result of the Experimental example 1, the three-dimensional pattern may be visually identified during the day. Meanwhile, as illustrated in FIG. 7, since the vehicle panels according to the Comparative Example 4-1-1 to the Comparative Example 4-2-7 have a relatively high content of the pigment included in the three-dimensional pattern part, the lighting effect is lowered, thereby not clearly identifying the three-dimensional effect of the three-dimensional pattern.

That is, if the three-dimensional pattern, which is included in the vehicle panel according to one form of the present disclosure including the three-dimensional pattern part including the opaque carbonate including the polycarbonate of 99.994 wt % and the pigment of 0.006 wt % including the carbon black and the coating part manufactured in the thickness of 6 to 15 um (50%) so as to include the pigment of 1.5% to 3.5%, is light-emitted, the luminance is 0.5 to 6 cd/m² and the transmittance is 1 to 30%, and preferably, the luminance is 1 to 3 cd/m² and the transmittance is 3 to 10%, thereby having good expressiveness of the edge portion and not decreasing the lighting effect even if the light source is turned on at night and the light is radiated to the three-dimensional pattern. Thus, it may be confirmed that the three-dimensional effect of the light-emitted three-dimensional pattern is good. Furthermore, by radiating the light source from the inside instead of the conventional method for radiating the light source to the side surface, it is possible to reduce the loss of the light source and maximally provide the light-emitting region using the diffusion plate, and by locating the light source inside the diffusion plate to be spaced apart from the diffusion plate by a specific distance, it is possible to improve the three-dimensional effect and implement the gradation effect.

What is claimed is:

1. A vehicle panel comprising:
a panel main body comprising a three-dimensional pattern part including a three-dimensional pattern engraved on a back surface of the three-dimensional pattern part, and a coating part coated on an upper surface of the three-dimensional pattern part; and
a lighting part provided such that a light is emitted from an inner surface of the panel main body,
wherein the lighting part comprises: a diffusion plate provided to be spaced at a location corresponding to the panel main body, and a light source located inside the diffusion plate and provided to be spaced apart from the diffusion plate.

2. The vehicle panel of claim 1, wherein the three-dimensional pattern is engraved in a thickness of 0.2 to 1.5 mm.

3. The vehicle panel of claim 1, wherein the three-dimensional pattern comprises: one or more shapes selected from a group consisting of a rectangular parallelepiped shape, a trapezoidal shape, a diamond shape, a hemispherical shape, and a combination thereof.

4. The vehicle panel of claim 1, wherein the three-dimensional pattern part comprises: one or more materials selected from a group consisting of polycarbonate (PC), poly(methyl methacrylate) (PMMA), polycarbonate/polyethylene terephthalate glycol (PC/PETG) composite, acrylonitrile butadiene styrene (ABS) copolymer, a PC/ABS composite, and a combination thereof.

5. The vehicle panel of claim 4, wherein the polycarbonate (PC) is selected from a group consisting of transparent polycarbonate, opaque polycarbonate, and a combination thereof.

6. The vehicle panel of claim 5, wherein the opaque polycarbonate comprises:
the polycarbonate of 99.991 to 99.997 wt %; and
the pigment of 0.003 to 0.009 wt % comprising the carbon black.

7. The vehicle panel of claim 1, wherein the coating part comprises:
one or more paints selected from a group consisting of achromatic paint, chromatic paint, and a combination thereof; and
a pigment.

8. The vehicle panel of claim 1, wherein the coating part comprises:
a paint of 95 to 99.5 wt %; and
a pigment of 0.5 to 5 wt %.

9. The vehicle panel of claim 1, wherein the thickness of the coating part is 2 to 22 um.

10. The vehicle panel of claim 1, wherein the diffusion plate comprises: a diffusion agent comprising one or more materials selected from a group consisting of silicone dioxide (SiO₂), silicone rubber, titanium dioxide (TiO₂), and PMMA.

11. The vehicle panel of claim 10, wherein the content of the diffusion agent is 0.5 to 2 wt % based on a total 100 wt % of the diffusion plate.

12. The vehicle panel of claim 1, wherein a separation distance between the light source and the diffusion plate is 10 to 15 mm.

13. The vehicle panel of claim 1, wherein a separation distance between the diffusion plate and the three-dimensional pattern part is 2 to 4 mm.

14. The vehicle panel of claim 1, wherein the diffusion plate has an increasing thickness from an center portion toward an outer portion.

15. The vehicle panel of claim 1, wherein a thickness of the diffusion plate is 1.5 to 3.8 mm.

16. The vehicle panel of claim 1, wherein the lighting part further comprises: a diffusion film provided on an upper surface of the diffusion plate.

17. The vehicle panel of claim 16, wherein the diffusion film comprises: one or more materials selected from a group consisting of polycarbonate (PC), poly(methyl methacrylate (PMMA), and polyethylene terephthalate (PET).

18. The vehicle panel of claim 16, wherein when emitting light, the three-dimensional pattern has a luminance of 0.5 to 6 cd/m², a transmittance of 1 to 30%, and a brightness (L*) of 2 to 40.

19. The vehicle panel of claim 18, wherein when emitting light, the contrast of the three-dimensional pattern is adjusted by adjusting the brightness (L*).

20. The vehicle panel of claim 1, wherein the vehicle panel comprises: one or more types selected from a group consisting of an embedded component garnish, a bumper garnish, a rear garnish, a tailgate garnish, a front garnish, a side garnish, a filler garnish, a fender garnish, a side step garnish, a front door molding, a front rear molding, a bumper molding, a door scuff, a label, and a combination thereof.
